(19) United States
(12) Patent Application Publication
(10) Pub. No.: US 2025/0220435 A1
(43) Pub. Date: Jul. 3, 2025

(54) SECURITY NETWORK SLICE FOR CLOUD-BASED WIRELESS NETWORKS

(71) Applicant: DISH Wireless L.L.C., Englewood, CO (US)

(72) Inventors: Daniel Brian Steeves, Lakewood, CO (US); James M. Adkins, III, Bennett, CO (US); Ravi Madhavan, Naperville, IL (US); Mohammad Dawood Shahdad, Aurora, CO (US); Dale Drew, Englewood, CO (US); Kevin Joseph Plunkett, Aurora, CO (US)

(21) Appl. No.: 18/401,064

(22) Filed: Dec. 29, 2023

(51) Int. Cl. H04W 12/122; H04W 8/22; H04W 12/088

(52) U.S. Cl. CPC H04W 12/122; H04W 8/22; H04W 12/088

(57) ABSTRACT

A method includes receiving information representative of one or more actions taken by a user equipment device connected to a cloud-native wireless network. The method also includes selecting, based on the information, the user equipment device for monitoring network traffic originating from the user equipment device. The method also includes, in response to selecting the user equipment device, assigning the user equipment device to a network slice of the cloud-native wireless network, wherein the user equipment device is assigned to the network slice upon connecting to a radio tower of the cloud-native wireless network. The method also includes routing network traffic associated with the network slice through a module of the cloud-native wireless network that monitors the network traffic.

### TECHNICAL FIELD

This disclosure generally relates to cloud-based, or “cloud-native,” wireless networks (e.g., 5G core networks), including the screening and/or monitoring of activities performed by user equipment devices (“UE devices”) connected to such networks.

### BACKGROUND

Cellular networks (e.g., cellular radio access networks, cellular core networks, etc.) are telecommunications networks that include a number of distributed devices that send, receive, and/or process wireless signals across the network to provide coverage to a geographical area. For example, in 5G networks, these devices can include wireless equipment called “wireless cells,” “small cells,” or “cells,” which can be installed at wireless towers distributed throughout the geographic area. User equipment devices (“UE devices”) operated by users of a cellular network can connect to the wireless towers (e.g., radio towers) in order to interact with the cellular network and access the internet. To do so, the users (e.g., wireless customers, wireless subscribers, roaming users, etc.) often pay a provider of the cellular network (e.g., in accordance with a data plan or contract) to use a certain amount data (including unlimited data) on the network.

### SUMMARY

This document describes techniques for identifying UE devices deemed to be performing suspicious, malicious, or otherwise undesirable activity on a cloud-native cellular network such as a 5G open radio access network (O-RAN). Using the techniques described herein, UE devices that are identified as “bad actors” can be isolated to a separate network slice (sometimes referred to herein as a “security network slice”) supported by the overall 5G network infrastructure. Once assigned to access the internet through the separate security network slice, the UE devices identified as bad actors are (i) limited in their ability to interact with other, trusted UE devices connected to the cellular network and (ii) can have relevant network traffic (potentially all of their network traffic) routed through a “scrubbing center” module of the cellular network where the network traffic is screened and scrubbed to prevent (e.g., reduce the likelihood of) suspicious, malicious, or otherwise undesirable actions from propagating to the internet. In addition, the security network slice can be managed, for example, to limit a bandwidth usable by the UE devices identified as bad actors, providing even further control of undesirable network traffic by a provider of the cellular network (e.g., a mobile virtual network operator (“MVNO”)).

In one aspect, a method is featured. The method includes receiving information representative of one or more actions taken by a user equipment device connected to a cloud-native wireless network. The method also includes selecting, based on the information, the user equipment device for monitoring network traffic originating from the user equipment device. The method also includes, in response to selecting the user equipment device, assigning the user equipment device to a network slice of the cloud-native wireless network, wherein the user equipment device is assigned to the network slice upon connecting to a radio tower of the cloud-native wireless network. The method also includes routing network traffic associated with the network slice through a module of the cloud-native wireless network that monitors the network traffic.

Implementations can include the examples described below and herein elsewhere. In some implementations, receiving the information representative of one or more actions taken by the user equipment device can include receiving feedback about the one or more actions taken by the user equipment device from an internet host. In some implementations, receiving the information representative of one or more actions taken by the user equipment device can include collecting data about the one or more actions taken by the user equipment device, and selecting the user equipment device can include determining, based on the collected data, that the one or more actions taken by the user equipment device are in violation of a contract. In some implementations, the method can include, in response to selecting the user equipment device, removing an assignment of the user equipment device to a network slice of the cloud-native wireless network that the user equipment device is currently assigned to. In some implementations, assigning the user equipment device to the network slice of the cloud-native wireless network can include assigning the user equipment device an identifier associated with the assigned network slice. In some implementations, the user equipment device remains assigned to the network slice even as the user equipment device connects to other radio towers of the cloud-native wireless network. In some implementations, the module of the cloud-native wireless network that monitors the network traffic also scrubs the network traffic. In some implementations, the method can include managing one or more characteristics of the network slice including a bandwidth of the network slice. In some implementations, the method can include, in response to selecting the user equipment device, assigning the user equipment device a policy function that affects interactions of the user equipment device with the cloud-native wireless network. In some implementations, the method can include selecting additional user equipment devices for monitoring network traffic originating from the additional user equipment devices, and in response to selecting the additional user equipment devices, scaling resources of the cloud-native wireless network that are used to operate the module of the cloud-native wireless network that monitors the network traffic. In some implementations, the method can include determining that the user equipment device no longer warrants monitoring network traffic originating from the user equipment device; in response to determining that the user equipment device no longer warrants monitoring network traffic originating from the user equipment device, removing an assignment of the user equipment device to the network slice; and assigning the user equipment device to another network slice.

In another aspect, a wireless network is featured. The wireless network includes a cloud-native core network including at least one computing device and a plurality of network slices. The wireless network also includes a plurality of radio towers configured to communicate with the cloud-native core network. The wireless network also includes a module configured to monitor network traffic. The at least one computing device of the cloud-native core network includes a memory configured to store instructions, and one or more processors configured to execute the instructions to perform operations. The operations include receiving information representative of one or more actions taken by a user equipment device connected to the wireless network. The operations also include selecting, based on the information, the user equipment device for monitoring network traffic originating from the user equipment device. The operations also include, in response to selecting the user equipment device, assigning the user equipment device to a network slice of the plurality of network slices, wherein the user equipment device is assigned to the network slice upon connecting to a radio tower of the plurality of radio towers. The operations also include routing network traffic associated with the network slice through the module configured to monitor network traffic.

Implementations can include the examples described below and herein elsewhere. In some implementations, receiving the information representative of one or more actions taken by the user equipment device can include receiving feedback about the one or more actions taken by the user equipment device from an internet host. In some implementations, receiving the information representative of one or more actions taken by the user equipment device can include collecting data about the one or more actions taken by the user equipment device, and selecting the user equipment device can include determining, based on the collected data, that the one or more actions taken by the user equipment device are in violation of a contract. In some implementations, the operations can include, in response to selecting the user equipment device, removing an assignment of the user equipment device to a network slice of the plurality of network slices that the user equipment device is currently assigned to. In some implementations, assigning the user equipment device to the network slice of the plurality of network slices can include assigning the user equipment device an identifier associated with the assigned network slice. In some implementations, the user equipment device remains assigned to the network slice even as the user equipment device connects to other radio towers of the plurality of radio towers. In some implementations, the module configured to monitor network traffic can be further configured to scrub the network traffic. In some implementations, the operations can include managing one or more characteristics of the network slice including a bandwidth of the network slice. In some implementations, the operations can include, in response to selecting the user equipment device, assigning the user equipment device a policy function that affects interactions of the user equipment device with the wireless network. In some implementations, the operations can include, selecting additional user equipment devices for monitoring network traffic originating from the additional user equipment devices, and in response to selecting the additional user equipment devices, scaling resources of the cloud-native core network that are used to operate the module configured to monitor network traffic. In some implementations, the operations can include determining that the user equipment device no longer warrants monitoring network traffic originating from the user equipment device; in response to determining that the user equipment device no longer warrants monitoring network traffic originating from the user equipment device, removing an assignment of the user equipment device to the network slice; and assigning the user equipment device to another network slice of the plurality of network slices.

In another aspect, one or more non-transitory machine-readable storage media are featured. The one or more non-transitory machine-readable storage media store instructions that are executed (e.g., by one or more processors of a computing device) to perform operations. The operations include receiving information representative of one or more actions taken by a user equipment device connected to a cloud-native wireless network. The operations also include selecting, based on the information, the user equipment device for monitoring network traffic originating from the user equipment device. The operations also include, in response to selecting the user equipment device, assigning the user equipment device to a network slice of the cloud-native wireless network, wherein the user equipment device is assigned to the network slice upon connecting to a radio tower of the cloud-native wireless network. The operations also include routing network traffic associated with the network slice through a module of the cloud-native wireless network that monitors the network traffic.

Implementations can include the examples described below and herein elsewhere. In some implementations, receiving the information representative of one or more actions taken by the user equipment device can include receiving feedback about the one or more actions taken by the user equipment device from an internet host. In some implementations, receiving the information representative of one or more actions taken by the user equipment device can include collecting data about the one or more actions taken by the user equipment device, and selecting the user equipment device can include determining, based on the collected data, that the one or more actions taken by the user equipment device are in violation of a contract. In some implementations, the operations can include, in response to selecting the user equipment device, removing an assignment of the user equipment device to a network slice of the cloud-native wireless network that the user equipment device is currently assigned to. In some implementations, assigning the user equipment device to the network slice of the cloud-native wireless network can include assigning the user equipment device an identifier associated with the assigned network slice. In some implementations, the user equipment device remains assigned to the network slice even as the user equipment device connects to other radio towers of the cloud-native wireless network. In some implementations, the module of the cloud-native wireless network that monitors the network traffic also scrubs the network traffic. In some implementations, the operations can include managing one or more characteristics of the network slice including a bandwidth of the network slice. In some implementations, the operations can include, in response to selecting the user equipment device, assigning the user equipment device a policy function that affects interactions of the user equipment device with the cloud-native wireless network. In some implementations, the operations can include selecting additional user equipment devices for monitoring network traffic originating from the additional user equipment devices, and in response to selecting the additional user equipment devices, scaling resources of the cloud-native wireless network that are used to operate the module of the cloud-native wireless network that monitors the network traffic. In some implementations, the operations can include determining that the user equipment device no longer warrants monitoring network traffic originating from the user equipment device; in response to determining that the user equipment device no longer warrants monitoring network traffic originating from the user equipment device, removing an assignment of the user equipment device to the network slice; and assigning the user equipment device to another network slice.

Various implementations of the technology described herein may provide one or more of the following advantages. Compared to cellular networks in which UE devices are not screened or monitored prior to being allowed to use the network for internet access, the techniques described herein can keep the users of the cellular network secure and can protect the online reputations (also referred to as “Internet reputation” or “e-reputation”) of the users and/or the cellular network provider (e.g., any IP addresses associated with the cellular network provider). By protecting the online reputations of the network users and/or the cellular network provider, the techniques described herein can prevent certain IP addresses from being blacklisted by service providers or internet hosting companies due to the actions a few bad actors on the network.

The technology described herein also has the advantages of (i) making it difficult for bad actors on the cellular network to realize their actions are being monitored and/or scrubbed (thereby preventing the bad actors from potentially taking preemptive evasive/preventative measures to avoid being apprehended) and (ii) providing the cellular network provider significant control over the activities of the UE devices that are identified as bad actors. For example, one approach for addressing bad actors on the network is to simply disconnect the UE devices that are identified as bad actors from the internet. However, if such an approach were implemented, the users of those UE devices would quickly realize that they have been flagged as bad actors and might simply get a new SIM card that allows them to connect again to the cellular network. On the other hand, using the techniques described herein, the UE devices that are identified as bad actors are still able to access the internet, but their ability to perform undesirable or malicious actions is substantially reduced through their isolation on a security network slice and/or the monitoring of their network traffic by the scrubbing center. As such, using the technology disclosed herein, it may not be as obvious to the bad actors on the network that they have been identified as bad actors.

Another advantage of the technology described herein is that it allows for separating out bad actors on the cellular network much earlier (e.g., much closer to the bad actor) than some existing approaches for rooting out bad actors on the network. For example, using the techniques described below, UE devices that are identified as being bad actors can be assigned to a network security slice (and potentially unassigned from all other network slices) upon connecting to a wireless tower (e.g., a radio tower) of the cellular network. Thus, the network traffic associated with the alleged bad actors can be isolated for further monitoring and/or scrubbing before the potentially malicious traffic becomes co-mingled with the network traffic associated with other UE devices connected to the network. This contrasts with existing approaches, for example, where the network traffic from bad actors is identified and isolated at a router, which can result in the co-mingling of network traffic associated with the bad actors and network traffic associated with other UE devices.

Yet another advantage of the technology described herein is that in enables dynamic scaling of scrubbing capability (e.g., the prevention of suspicious, malicious, or otherwise undesirable network traffic from UE devices identified as bad actors). In existing cellular networks that provide traffic scrubbing capability (e.g., via a “scrubbing center” module), one of the major challenges of providing this functionality is predicting the volume of traffic that will need to be sent to and processed by the scrubbing center. Relatedly, it may need to be determined how many servers, how much computing power, etc. will be needed to operate the scrubbing center at various volumes of traffic. In contrast, because the technology described herein is implemented on a cloud-native wireless network (e.g., a 5G Core network), such determinations need not be made. Instead, statistical multiplexing implemented on the cloud allows for efficient and rapid scaling of resources needed to operate the scrubbing center while requiring far less future planning.

Other features and advantages of the description will become apparent from the following description, and from the claims. Unless otherwise defined, the technical and scientific terms used herein have the same meaning as commonly understood by one of ordinary skill in the art to which this invention belongs.

### BRIEF DESCRIPTION OF DRAWINGS

FIG. 1A illustrates a system comprising multiple user equipment devices (“UE devices”) connected to the internet via a cloud-native wireless network.

FIG. 1B illustrates the system of FIG. 1A modified to include multiple network slices and a scrubbing center.

FIG. 2 is a flowchart showing an example process for routing network traffic through a module of a cloud-native wireless network that monitors the network traffic.

FIG. 3 is a diagram illustrating an example of a computing environment.

### DETAILED DESCRIPTION

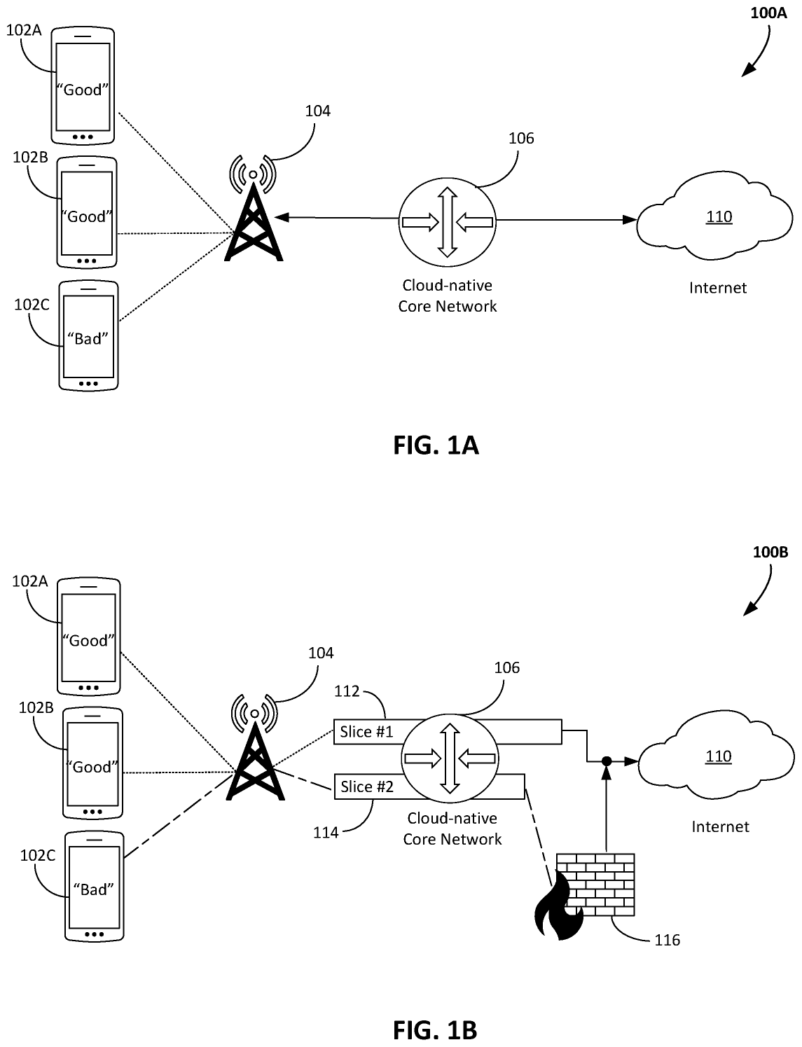

In many cellular networks such as 5G networks, end users and their associated UE devices (e.g., smartphones, tablets, laptops, etc.) are not screened and/or monitored prior to being allowed to use the cellular network for internet access. Referring to FIG. 1A, a system 100A is illustrated including various UE devices 102A-102C connected to the internet 110 via a cloud-native wireless network. The cloud-native wireless network includes a cloud-native core network 106 and a plurality of wireless towers (e.g., radio tower 104). One example of a cloud-native wireless network is a 5G network with a 5G Core network (corresponding to the cloud-native core network 106) and a plurality of 5G towers (corresponding to the radio tower 104). However, in some cases, other cloud-native wireless network such as cloud-based 4G networks can be implemented.

In the example shown in FIG. 1A, the UE devices 102A-102C are all connected to a radio tower 104 of the cloud-native wireless network, which in turn communicates (either directly or indirectly through other wireless equipment) with the cloud-native core network 106 (e.g., a 5G Core network). The cloud-native core network 106 is responsible for a variety of functions within the cellular network that makes communication possible such as authentication, authorization, and data and policy management. By connecting to the cloud-native core network 106 via the radio tower 104, the UE devices 102A-102C are able to access the internet 110.

In some cases, a portion of the UE devices (e.g., UE device 102C) may be associated with users who are “bad actors” on the network. In this context, “bad actors” can refer to users (and their associated UE devices) that perform, or seek to perform, suspicious, malicious, and/or otherwise undesirable activities using resources of the cellular network. Malicious traffic from bad actors that propagates out to the internet 110 can have consequences such as penalization and/or suppression for other “good” or “normal” users on the network (e.g., users associated with the UE device 102A, 102B) as well as the cellular network provider itself. For example, IP addressing within the cellular network can be implemented by sharing a pool of IP addresses across all UE devices connected to the network. If it is determined by a service provider or internet host that a particular IP address belonging to the pool of IP addresses is connected to malicious activity, then one or more IP addresses from the pool (and possibly the entire pool of IP addresses associated with the cellular network provider) can be blacklisted, resulting in suppressed access to internet services and sites for those IP addresses. Therefore, if a UE device that is connected to the 5G network (e.g., UE device 102C) is deemed to be acting in a questionable or malicious way, it can be desirable to isolate the questionable user to a more secured and monitored infrastructure to stop malicious traffic from propagating out to the internet 110 (e.g., to protect the rest of the users on that network infrastructure/IP address space from Internet reputation-based penalties affecting other consumers of the cellular network).

In the system 100A shown in FIG. 1A, no differentiation is made between bad actors (e.g., UE device 102C) and good actors (e.g., UE devices 102A, 102B), and all of the UE devices 102A-102C are treated similarly by the cloud-native core network 106 to access the internet 110. However, referring now to FIG. 1B, a modified system 100B is illustrated that includes various features for addressing bad actors identified on the network. Like the system 100A, the system 100B includes multiple UE devices 102A-102C (including good actors 102A, 102B and bad actor 102C) that are connected to a radio tower 104 of the cloud-native wireless network. Also like the system 100A, in the system 100B, the radio tower 104 communicates (either directly or indirectly through other wireless equipment) with the cloud-native core network 106 (e.g., a 5G Core network) to enable the UE devices 102A-102C to access the internet 110. However, as described in further detail below, the system 100B uniquely combines operations of the cloud-native core network 106 with Radio Access Network (RAN) slicing, and scrubbing center capabilities to (i) isolate and monitor network traffic originating from bad actors (e.g., UE device 102C), (ii) stop, or at least reduce the likelihood of, malicious traffic from propagating out to the internet 110 at large, and (iii) protect the Internet reputation of the cellular network provider and its customers.

One advantage of the system 100B is that it is able to separate out network traffic associated with bad actors (e.g. UE device 102C) at the radio tower 104, before the network traffic associated with bad actors is co-mingled with network traffic from other, good actors (e.g., UE devices 102A, 102B) at a router. When each of the UE devices 102A-102C registers at the radio tower 104, the radio tower 104 sends a message to the cloud-native core network 106, which in turn can authorize each UE device for access to a particular network slice by assigning the UE device an identifier known as a “slice ID.” This “slice ID” is then sent back to the radio tower 104 and to the UE devices 102A-102C, where the slice ID is stored. The “slice ID” is a logical identifier that directs the radio tower 104 as to where the traffic from each UE device is allowed to go. The cellular network then uses the “slice ID” logical identifier to direct traffic associated with each UE device towards a particular network slice.

In some implementations, in addition to assigning each UE device to a particular network slice, the same UE device can be unassigned (and possibly forcibly unassigned) from any other network slices that the UE device is already assigned to (e.g., a network slice that the UE device is currently connected to and/or assigned to). In some implementations, once the UE device is assigned to a particular network slice, it remains assigned to that particular network slice even as the UE device moves around and connects to other radio towers of the cellular network.

The “slice ID” assigned to each of the UE devices 102A-102C can be dependent on whether the UE device is classified by the cloud-native core network 106 as either a good actor or a bad actor (although in some implementations, additional and/or alternative classifications can be used). In some implementations, the default assumption is that all of the UE devices 102A-102C are good actors until information about one or more actions taken by any of the UE devices suggests otherwise. For example, the cellular network provider (or another party) could sample the network traffic associated with the various UE devices 102A-102C using a detection function and then analyze the network traffic for each device to determine if it is indicative of any of the UE devices being a bad actor (including violating an end-user license agreement of the cellular network provider). In other cases, the cellular network provider could receive feedback from a third-party internet host or service provider regarding alleged suspicious, malicious, or otherwise undesirable activity of one or more of the UE devices 102A-102C.

As shown in the example system 100B shown in FIG. 1B, the traffic from good actors (e.g., UE devices 102A, 102B) can be directed through a first network slice 112, and the traffic from bad actors (e.g., UE device 102C) can be directed through a second network slice 114 (sometimes referred to herein as a “security network slice”). For clarity of explication, in the example shown in FIG. 1, the system 100B includes just two network slices. However, in other implementations, additional network slices can be implemented. In general, the term “network slice” is used in this application to refer to a logical separation of services (e.g., a separate packet core, a separate user plane function, etc.) produced by RAN slicing—a technique that enables the creation of multiple virtual RANs or “slices” on the shared physical infrastructure of the overall cellular network.

In the system 100B, the first network slice 112 is a network slice that allows for access to the internet 110 for good actors (e.g., UE devices 102A, 102B) much in the same way as in the system 100A (e.g., without further monitoring and/or scrubbing of network traffic from the good actors). On the other hand, the security network slice 114 routes network traffic from the bad actors (e.g., UE device 102C) through a module of the cellular network referred to as a “scrubbing center” 116 (also referred to as a “traffic scrubbing center” or a “monitoring center”). In some implementations, in addition to isolating bad actors to the security network slice 114 and using the scrubbing center 116, other differences can be implemented between the network slices 112, 114. For example, slice management techniques can be used to create differential bandwidths between the two network slices 112, 114 (e.g., reducing the bandwidth available to the security network slice 114 compared to the network slice 112). In addition, policy management functions can also be used for devices in the security network slice 114 to cut down bandwidth for bad actors (e.g., UE device 102C).

The scrubbing center 116 is an instantiated security domain that can include a firewall and multiple security features that each of the bad actors (e.g., UE device 102C) must traverse to get to and from the internet 110. For example, the scrubbing center 116 can monitor the network traffic associated with the UE device 102C (e.g., packet-by-packet) to look for port scanning, malicious attacks, violations of an end-user license agreement of the cellular network provider, and/or any other signature behaviors traditionally prevented by firewalls. Upon identifying any of these behaviors, the scrubbing center 116 can stop that traffic from occurring and from being initiated by the UE device 102C. In other words, the scrubbing center 116 allows good traffic to propagate to the internet 110 while preventing bad traffic. An advantage of this approach is that it can be harder for a bad actor (e.g., UE device 102C or a user operating the UE device 102) to realize they've been identified as a bad actor compared to, for example, an approach that entails disconnecting the UE device 102C from the internet 110 completely. Just as a UE device can be seamlessly mapped to the security network slice 114 upon being identified as a bad actor, UE devices can likewise be mapped back to the security network 112 (e.g., using the slice ID assignment techniques described above) once they are determined to no longer be a threat. For example, upon determining that a UE device (e.g., UE device 102C) no longer warrants further monitoring and/or traffic scrubbing, the UE device can be unassigned to the security network slice 114 and assigned to the network slice 112.

Another important aspect of the scrubbing center 116 is that its functionality can be dynamically scaled. One of the major challenges of providing traffic scrubbing functionality is predicting the volume of traffic that will need to be sent to and processed by the scrubbing module. Relatedly, it may need to be determined how many servers, how much computing power, etc. will be needed to operate the scrubbing module at various volumes of traffic. In contrast, because the technology described herein is implemented on a cloud-native wireless network (e.g., a 5G Core network), such determinations need not be made. Instead, statistical multiplexing implemented on the cloud allows for efficient and rapid scaling of resources needed to operate the scrubbing center 116 while requiring far less future planning.

Using the techniques described herein, the system 100B is able to protect not only the good actors in the network (e.g., UE device 102A, 102B) from bad actors (e.g., UE device 102C) by isolating the bad actors to a separate network slice (e.g., security network slice 114), but also the internet as a whole (e.g., by routing the security network slice 114 through the scrubbing center 116 to reduce the likelihood of harmful traffic from propagating to the internet 110). The techniques described herein also protect the cellular network provider itself (and its customers) from reputational harm that can be incurred due to malicious activity by a few bad actors using the cellular network.

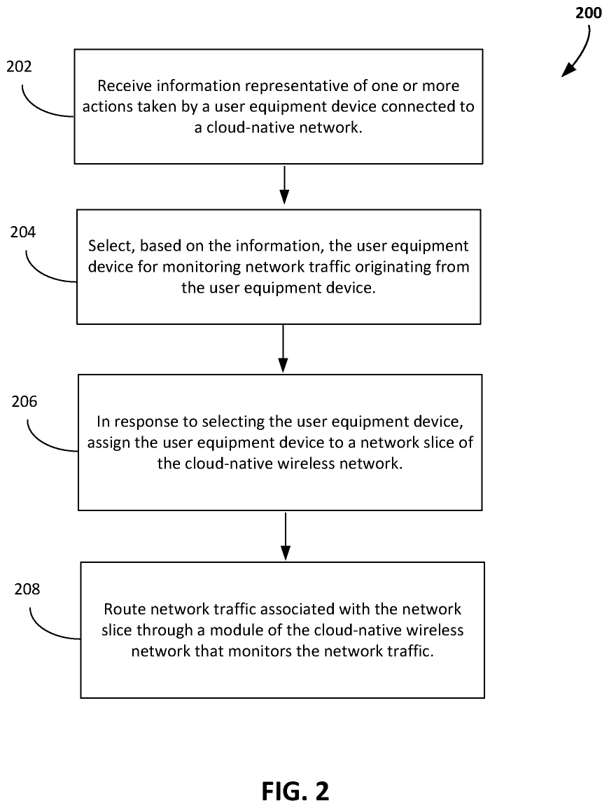

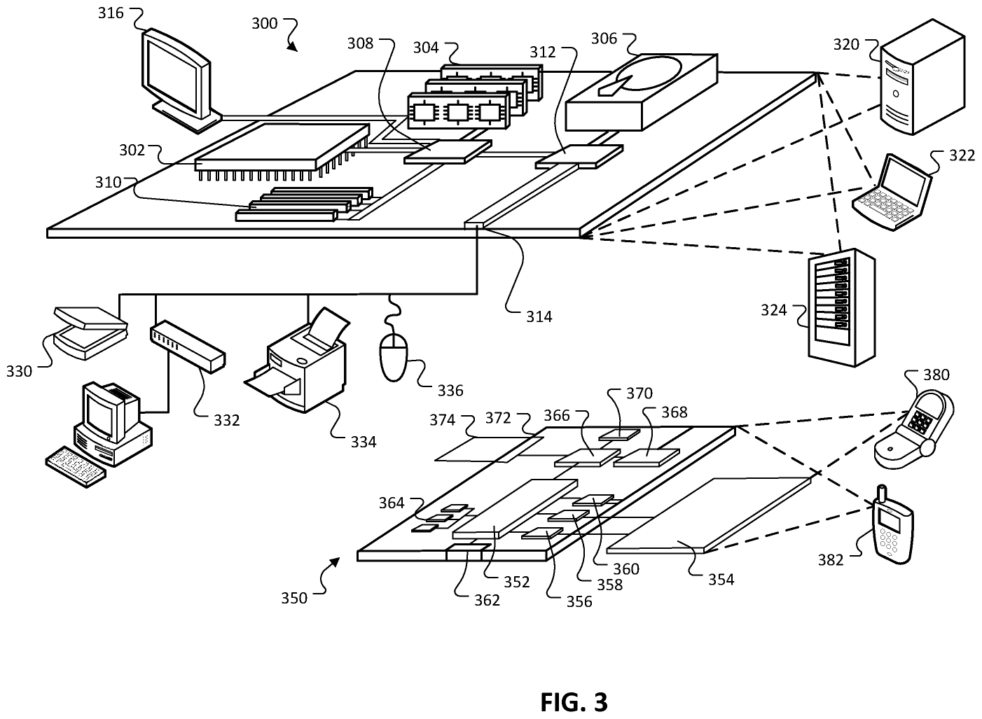

FIG. 2 illustrates an example process 200 for routing network traffic associated with a network slice (e.g., the security network slice 114) through a module of a cloud-native wireless network that monitors the network traffic (e.g., the scrubbing center 116). In some implementations, operations of the process 200 can be executed by one or more computing devices or mobile computing devices such as those described below in relation to FIG. 3. In some implementations, these computing devices or mobile computing devices can be part of the hardware that makes up the cloud-native wireless network (e.g., the cloud-native core network 106).

Operations of the process 200 include receiving information representative of one or more actions taken by a user equipment device connected to a cloud-native wireless network (202). For example, the user equipment device can correspond to any of the UE devices 102A-102C shown in FIG. 1B, and the cloud-native wireless network can include the cloud-native core network 106 and the radio tower 104. In some implementations, receiving the information representative of one or more actions taken by the user equipment device can include receiving feedback about the one or more actions (e.g., suspicious, malicious, and/or otherwise undesirable actions) taken by the user equipment device from an internet host. In some implementations, receiving the information representative of one or more actions taken by the user equipment device can include collecting data about the one or more actions taken by the user equipment device (e.g., using a detection function that samples traffic from the UE device).

Operations of the process 200 also include selecting, based on the information, the user equipment device for monitoring network traffic originating from the user equipment device (204). For example, as described in relation to FIG. 1B, the selected user equipment device can correspond to the UE device 102C, which is identified as a bad actor based on information representative of suspicious, malicious, and/or otherwise undesirable activity. In some implementations, selecting the user equipment device can include determining, based on the collected data, that the one or more actions taken by the user equipment device are in violation of a contract (e.g., an end-user license agreement of the cellular network provider).

Operations of the process 200 also include, in response to selecting the user equipment device, assigning the user equipment device to a network slice of the cloud-native wireless network (206). In particular, the user equipment device can be assigned to the network slice (e.g., the security network slice 114 shown in FIG. 1B) upon connecting to a radio tower (e.g., radio tower 104) of the cloud-native wireless network. In some implementations, assigning the user equipment device to the network slice of the cloud-native wireless network can include assigning the user equipment device an identifier (e.g., a “slice ID”, as described above) associated with the assigned network slice. In some implementations, the user equipment device can remain assigned to the network slice even as the user equipment device connects to other radio towers of the cloud-native wireless network.

Operations of the process 200 also include routing network traffic associated with the network slice through a module of the cloud-native wireless network that monitors the network traffic (208). For example, the module of the cloud-native wireless network that monitors the network traffic can correspond to the scrubbing module 116 shown in FIG. 1B. In some implementations, the module of the cloud-native wireless network that monitors the network traffic also scrubs the network traffic (e.g., preventing bad traffic from propagating out to the internet).

Additional operations of the process 200 can include the following. In some implementations, the process 200 can include, in response to selecting the user equipment device, removing an assignment of the user equipment device to a network slice of the cloud-native wireless network that the user equipment device is currently assigned to (e.g., network slice 112). In some implementations, the process 200 can include managing one or more characteristics of the network slice including a bandwidth of the network slice. In some implementations, the process 200 can include, in response to selecting the user equipment device, assigning the user equipment device a policy function that affects interactions of the user equipment device with the cloud-native wireless network. In some implementations, the process 200 can include (i) selecting additional user equipment devices for monitoring network traffic originating from the additional user equipment devices, and (ii) in response to selecting the additional user equipment devices, scaling resources of the cloud-native wireless network that are used to operate the module of the cloud-native wireless network that monitors the network traffic (e.g., the scrubbing center 116). In some implementations, the process 200 can include determining that the user equipment device no longer warrants monitoring network traffic originating from the user equipment device; in response to determining that the user equipment device no longer warrants monitoring network traffic originating from the user equipment device, removing an assignment of the user equipment device to the network slice (e.g., the security network slice 114); and assigning the user equipment device to another network slice (e.g., the network slice 112).

FIG. 3 shows an example of a computing device 300 and a mobile computing device 350 that are employed to execute implementations of the present disclosure. For example, the computing device 300 and/or the mobile computing device 350 can be part of the cloud-native core network 106 shown in FIGS. 1A, 1B and can be employed to execute the processes 400 and 500. The mobile computing device 350 is intended to represent various forms of mobile devices, such as personal digital assistants, cellular telephones, smart-phones, AR devices, and other similar computing devices. The components shown here, their connections and relationships, and their functions, are meant to be examples only, and are not meant to be limiting.

The computing device 300 includes a processor 302, a memory 304, a storage device 306, a high-speed interface 308, and a low-speed interface 312. In some implementations, the high-speed interface 308 connects to the memory 304 and multiple high-speed expansion ports 310. In some implementations, the low-speed interface 312 connects to a low-speed expansion port 314 and the storage device 304. Each of the processor 302, the memory 304, the storage device 306, the high-speed interface 308, the high-speed expansion ports 310, and the low-speed interface 312, are interconnected using various buses, and may be mounted on a common motherboard or in other manners as appropriate. The processor 302 can process instructions for execution within the computing device 300, including instructions stored in the memory 304 and/or on the storage device 306 to display graphical information for a graphical user interface (GUI) on an external input/output device, such as a display 316 coupled to the high-speed interface 308. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 304 stores information within the computing device 300. In some implementations, the memory 304 is a volatile memory unit or units. In some implementations, the memory 304 is a non-volatile memory unit or units. The memory 304 may also be another form of a computer-readable medium, such as a magnetic or optical disk.

The storage device 306 is capable of providing mass storage for the computing device 300. In some implementations, the storage device 306 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 302, perform one or more methods, such as those described above. The instructions can also be stored by one or more storage devices, such as computer-readable or machine-readable mediums, such as the memory 304, the storage device 306, or memory on the processor 302.

The high-speed interface 308 manages bandwidth-intensive operations for the computing device 300, while the low-speed interface 312 manages lower bandwidth-intensive operations. Such allocation of functions is an example only. In some implementations, the high-speed interface 308 is coupled to the memory 304, the display 316 (e.g., through a graphics processor or accelerator), and to the high-speed expansion ports 310, which may accept various expansion cards. In the implementation, the low-speed interface 312 is coupled to the storage device 306 and the low-speed expansion port 314. The low-speed expansion port 314, which may include various communication ports (e.g., Universal Serial Bus (USB), Bluetooth, Ethernet, wireless Ethernet) may be coupled to one or more input/output devices. Such input/output devices may include a scanner, a printing device, or a keyboard or mouse. The input/output devices may also be coupled to the low-speed expansion port 314 through a network adapter. Such network input/output devices may include, for example, a switch or router.

The computing device 300 may be implemented in a number of different forms, as shown in FIG. 3. For example, it may be implemented as a standard server 320, or multiple times in a group of such servers. In addition, it may be implemented in a personal computer such as a laptop computer 322. It may also be implemented as part of a rack server system 324. Alternatively, components from the computing device 300 may be combined with other components in a mobile device, such as a mobile computing device 350. Each of such devices may contain one or more of the computing device 300 and the mobile computing device 350, and an entire system may be made up of multiple computing devices communicating with each other.

The mobile computing device 350 includes a processor 352; a memory 364; an input/output device, such as a display 354; a communication interface 366; and a transceiver 368; among other components. The mobile computing device 350 may also be provided with a storage device, such as a micro-drive or other device, to provide additional storage. Each of the processor 352, the memory 364, the display 354, the communication interface 366, and the transceiver 368, are interconnected using various buses, and several of the components may be mounted on a common motherboard or in other manners as appropriate. In some implementations, the mobile computing device 350 may include a camera device(s).

The processor 352 can execute instructions within the mobile computing device 350, including instructions stored in the memory 364. The processor 352 may be implemented as a chipset of chips that include separate and multiple analog and digital processors. For example, the processor 352 may be a Complex Instruction Set Computers (CISC) processor, a Reduced Instruction Set Computer (RISC) processor, or a Minimal Instruction Set Computer (MISC) processor. The processor 352 may provide, for example, for coordination of the other components of the mobile computing device 350, such as control of user interfaces (UIs), applications run by the mobile computing device 350, and/or wireless communication by the mobile computing device 350.

The processor 352 may communicate with a user through a control interface 358 and a display interface 356 coupled to the display 354. The display 354 may be, for example, a Thin-Film-Transistor Liquid Crystal Display (TFT) display, an Organic Light Emitting Diode (OLED) display, or other appropriate display technology. The display interface 356 may include appropriate circuitry for driving the display 354 to present graphical and other information to a user. The control interface 358 may receive commands from a user and convert them for submission to the processor 352. In addition, an external interface 362 may provide communication with the processor 352, so as to enable near area communication of the mobile computing device 350 with other devices. The external interface 362 may provide, for example, for wired communication in some implementations, or for wireless communication in other implementations, and multiple interfaces may also be used.

The memory 364 stores information within the mobile computing device 350. The memory 364 can be implemented as one or more of a computer-readable medium or media, a volatile memory unit or units, or a non-volatile memory unit or units. An expansion memory 374 may also be provided and connected to the mobile computing device 350 through an expansion interface 372, which may include, for example, a Single in Line Memory Module (SIMM) card interface. The expansion memory 374 may provide extra storage space for the mobile computing device 350, or may also store applications or other information for the mobile computing device 350. Specifically, the expansion memory 374 may include instructions to carry out or supplement the processes described above, and may include secure information also. Thus, for example, the expansion memory 374 may be provided as a security module for the mobile computing device 350, and may be programmed with instructions that permit secure use of the mobile computing device 350. In addition, secure applications may be provided via the SIMM cards, along with additional information, such as placing identifying information on the SIMM card in a non-hackable manner.

The memory may include, for example, flash memory and/or non-volatile random access memory (NVRAM), as discussed below. In some implementations, instructions are stored in an information carrier. The instructions, when executed by one or more processing devices, such as processor 352, perform one or more methods, such as those described above. The instructions can also be stored by one or more storage devices, such as one or more computer-readable or machine-readable mediums, such as the memory 364, the expansion memory 374, or memory on the processor 352. In some implementations, the instructions can be received in a propagated signal, such as, over the transceiver 368 or the external interface 362.

The mobile computing device 350 may communicate wirelessly through the communication interface 366, which may include digital signal processing circuitry where necessary. The communication interface 366 may provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS). Such communication may occur, for example, through the transceiver 368 using a radio frequency. In addition, short-range communication, such as using a Bluetooth or Wi-Fi, may occur. In addition, a Global Positioning System (GPS) receiver module 370 may provide additional navigation- and location-related wireless data to the mobile computing device 350, which may be used as appropriate by applications running on the mobile computing device 350.

The mobile computing device 350 may also communicate audibly using an audio codec 360, which may receive spoken information from a user and convert it to usable digital information. The audio codec 360 may likewise generate audible sound for a user, such as through a speaker, e.g., in a handset of the mobile computing device 350. Such sound may include sound from voice telephone calls, may include recorded sound (e.g., voice messages, music files, etc.) and may also include sound generated by applications operating on the mobile computing device 350.

The mobile computing device 350 may be implemented in a number of different forms, as shown in FIG. 3. For example, it may be implemented a phone device 380, a personal digital assistant 382, and a tablet device (not shown). The mobile computing device 350 may also be implemented as a component of a smart-phone, AR device, or other similar mobile device.

Computing device 300 and/or 350 can also include USB flash drives. The USB flash drives may store operating systems and other applications. The USB flash drives can include input/output components, such as a wireless transmitter or USB connector that may be inserted into a USB port of another computing device.

Other embodiments and applications not specifically described herein are also within the scope of the following claims. Elements of different implementations described herein may be combined to form other embodiments not specifically set forth above. Elements may be left out of the structures described herein without adversely affecting their operation. Furthermore, various separate elements may be combined into one or more individual elements to perform the functions described herein.

1. A method comprising:
receiving information representative of one or more actions taken by a user equipment device connected to a cloud-native wireless network;
selecting, based on the information, the user equipment device for monitoring network traffic originating from the user equipment device;
in response to selecting the user equipment device, assigning the user equipment device to a network slice of the cloud-native wireless network, wherein the user equipment device is assigned to the network slice upon connecting to a radio tower of the cloud-native wireless network; and
routing network traffic associated with the network slice through a module of the cloud-native wireless network that monitors the network traffic.

2. The method of claim 1, wherein receiving the information representative of one or more actions taken by the user equipment device comprises receiving feedback about the one or more actions taken by the user equipment device from an internet host.

3. The method of claim 1,
wherein receiving the information representative of one or more actions taken by the user equipment device comprises collecting data about the one or more actions taken by the user equipment device, and
wherein selecting the user equipment device comprises determining, based on the collected data, that the one or more actions taken by the user equipment device are in violation of a contract.

4. The method of claim 1, further comprising, in response to selecting the user equipment device, removing an assignment of the user equipment device to a network slice of the cloud-native wireless network that the user equipment device is currently assigned to.

5. The method of claim 1, wherein assigning the user equipment device to the network slice of the cloud-native wireless network comprises assigning the user equipment device an identifier associated with the assigned network slice.

6. The method of claim 1, wherein the user equipment device remains assigned to the network slice even as the user equipment device connects to other radio towers of the cloud-native wireless network.

7. The method of claim 1, wherein the module of the cloud-native wireless network that monitors the network traffic also scrubs the network traffic.

8. The method of claim 1, further comprising managing one or more characteristics of the network slice including a bandwidth of the network slice.

9. (canceled)

10. The method of claim 1, further comprising:
selecting additional user equipment devices for monitoring network traffic originating from the additional user equipment devices, and
in response to selecting the additional user equipment devices, scaling resources of the cloud-native wireless network that are used to operate the module of the cloud-native wireless network that monitors the network traffic.

11. The method of claim 1, further comprising:
determining that the user equipment device no longer warrants monitoring network traffic originating from the user equipment device;
in response to determining that the user equipment device no longer warrants monitoring network traffic originating from the user equipment device, removing an assignment of the user equipment device to the network slice; and
assigning the user equipment device to another network slice.

12. A wireless network comprising:
a cloud-native core network comprising at least one computing device and a plurality of network slices;
a plurality of radio towers configured to communicate with the cloud-native core network; and
a module configured to monitor network traffic,
wherein the at least one computing device of the cloud-native core network comprises:
a memory configured to store instructions and
one or more processors configured to execute the instructions to perform operations comprising:
receiving information representative of one or more actions taken by a user equipment device connected to the wireless network,
selecting, based on the information, the user equipment device for monitoring network traffic originating from the user equipment device;
in response to selecting the user equipment device, assigning the user equipment device to a network slice of the plurality of network slices, wherein the user equipment device is assigned to the network slice upon connecting to a radio tower of the plurality of radio towers; and
routing network traffic associated with the network slice through the module configured to monitor network traffic.

13. The wireless network of claim 12, wherein receiving the information representative of one or more actions taken by the user equipment device comprises receiving feedback about the one or more actions taken by the user equipment device from an internet host.

14. The wireless network of claim 12,
wherein receiving the information representative of one or more actions taken by the user equipment device comprises collecting data about the one or more actions taken by the user equipment device, and
wherein selecting the user equipment device comprises determining, based on the collected data, that the one or more actions taken by the user equipment device are in violation of a contract.

15. The wireless network of claim 12, where in the operations further comprise, in response to selecting the user equipment device, removing an assignment of the user equipment device to a network slice of the plurality of network slices that the user equipment device is currently assigned to.

16. The wireless network of claim 12, wherein assigning the user equipment device to the network slice of the plurality of network slices comprises assigning the user equipment device an identifier associated with the assigned network slice.

17. The wireless network of claim 12, wherein the user equipment device remains assigned to the network slice even as the user equipment device connects to other radio towers of the plurality of radio towers.

18. The wireless network of claim 12, wherein the module configured to monitor network traffic is further configured to scrub the network traffic.

19. (canceled)

20. (canceled)

21. The wireless network of claim 12, wherein the operations further comprise:
selecting additional user equipment devices for monitoring network traffic originating from the additional user equipment devices, and
in response to selecting the additional user equipment devices, scaling resources of the cloud-native core network that are used to operate the module configured to monitor network traffic.

22. The wireless network of claim 12, wherein the operations further comprise:
determining that the user equipment device no longer warrants monitoring network traffic originating from the user equipment device;
in response to determining that the user equipment device no longer warrants monitoring network traffic originating from the user equipment device, removing an assignment of the user equipment device to the network slice; and
assigning the user equipment device to another network slice of the plurality of network slices.

23. One or more non-transitory machine-readable storage media storing instructions that are executed to perform operations comprising:
receiving information representative of one or more actions taken by a user equipment device connected to a cloud-native wireless network;
selecting, based on the information, the user equipment device for monitoring network traffic originating from the user equipment device;
in response to selecting the user equipment device, assigning the user equipment device to a network slice of the cloud-native wireless network, wherein the user equipment device is assigned to the network slice upon connecting to a radio tower of the cloud-native wireless network; and
routing network traffic associated with the network slice through a module of the cloud-native wireless network that monitors the network traffic.

24-33. (canceled)
